(19) United States
(12) Patent Application Publication
(10) Pub. No.: US 2019/0212964 A1
(43) Pub. Date: Jul. 11, 2019

(54) DISPLAY ASSEMBLY INCLUDING AT LEAST TWO DISPLAY DEVICES

(71) Applicant: SEAMLESS TECHNOLOGY INC., Taipei (TW)

(72) Inventors: I-WEI WU, New Taipei (TW); CHIH-LUNG HUNG, New Taipei (TW)

(21) Appl. No.: 16/239,573

(22) Filed: Jan. 4, 2019

Related U.S. Application Data
(60) Provisional application No. 62/615,385, filed on Jan. 9, 2018.

(51) Int. Cl. G06F 3/14; G09F 9/302

(52) U.S. Cl. CPC G06F 3/1446; G09G 2300/026; G09F 9/3026

(57) ABSTRACT

A display assembly includes at least two display devices and two image compensating elements at a junction of every adjacent two display devices. Each display device includes a front surface that is viewed by user. Two front surfaces of adjacent two display devices intersect to form an angle of less than 180 degrees. Each front surface defines a display area and a border area. Each image compensating element is on the front surface. Each image compensating element includes a light-incident surface covering the display area, a light-emitting surface coupling to the light-incident surface, and a connecting surface coupling between the light-incident surface and the light-emitting surface. Each image compensating element includes a plurality of light guiding channels. Light guiding paths of the light guiding channels curvedly extend along a direction from the light-incident surface toward the light-emitting surface.

### FIELD

The subject matter herein generally relates to a display assembly including at least two display devices.

### BACKGROUND

To realize a large display screen, a conventional method is to couple (referred to as “splicing”) a plurality of display devices together to realize a single large display screen. Each display device generally has a display area in which a plurality of display pixels are arranged and a border area surrounding the display area. However, when coupling several display devices together, the border areas form a netlike image over the full display image, therefore, the display image is non-continuous and greatly affecting presentation of the images.

Therefore, there is room for improvement in the art.

### BRIEF DESCRIPTION OF THE DRAWINGS

Implementations of the present technology will now be described, by way of embodiments only, with reference to the attached figures.

FIG. 1 is a top view of a display assembly according to a first embodiment of the present disclosure.

FIG. 2 is an enlarged view of a portion of the display assembly according to the first embodiment of the present disclosure.

FIG. 3 is an enlarged view of a portion of a display assembly according to a second embodiment of the present disclosure.

FIG. 4 is an enlarged view of a portion of a display assembly according to a third embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “coupled” is defined as coupled, whether directly or indirectly through intervening components, and is not necessarily limited to physical connections. The connection can be such that the objects are permanently coupled or releasably coupled. The term “comprising” when utilized, means “including, but not necessarily limited to”; it specifically indicates open-ended inclusion or membership in the so-described combination, group, series, and the like.

### First Embodiment

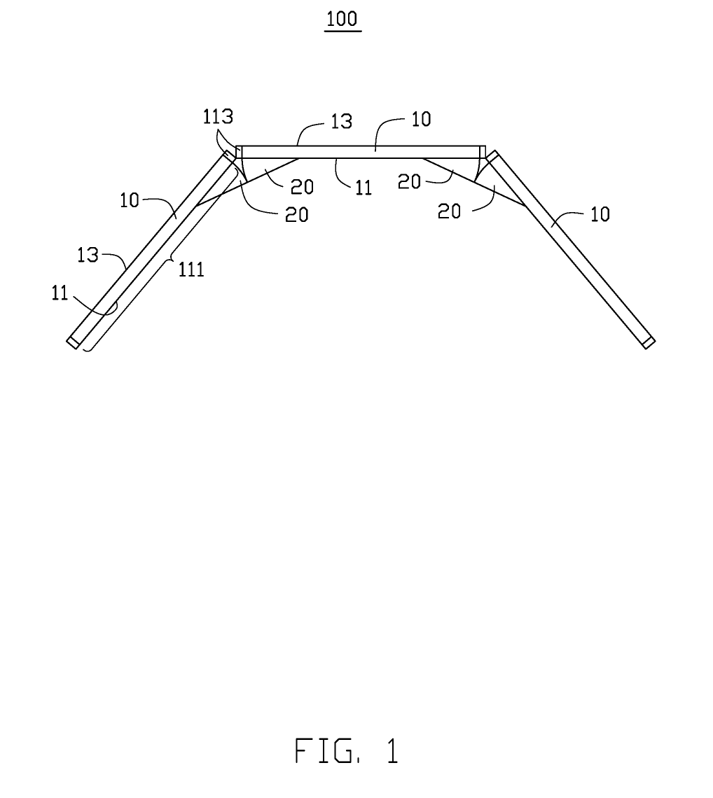

FIG. 1 illustrates a display assembly 100 of an embodiment. The display assembly includes three display devices 10 arranged in the manner of a triptych. Adjacent display devices 10 are not arranged side by side in one plane, but are tilted at an angle of less than 180 degrees from each other. Each display device 10 includes a front surface 11 and a back surface 13 opposite to the front surface 11. The front surface 11 is viewable and touchable by users. The front surface 11 defines a display area 111 for displaying images and a border area 113 outside the display area 111. In the present embodiment, the border area 113 is at opposite sides of the display area 111. The two front surfaces 11 of adjacent display devices 10 intersect at an angle of less than 180 degrees.

The number of the display devices 10 in the display assembly 100 is not limited to three. In other embodiments, the display assembly 100 may include two display devices 10 or four display devices 10, as long as the number of the display devices 10 is equal to or greater than two.

When adjacent display devices 10 are coupled, the two border areas 113 of the two display devices 10 are adjacently disposed at a junction of the two display devices 10. In the present embodiment, the two border areas 113 of the two display devices 10 are in contact with each other. In other embodiments, the two border areas 113 of the two display devices 10 may be spaced apart from each other.

As shown in FIG. 1, at least one image compensation component 20 is provided on the front surface 11 of each display device 10 in order to present a continuous or non-interrupted display by the display assembly 100 without being affected by the border areas 113 of the display devices 10 (no border being apparent to a viewer). The image compensation component 20 can transmit a portion of images such that images from different display devices 10 coupled together form a continuous and non-reticulated display viewable by users facing the front surfaces 11 of the display devices 10.

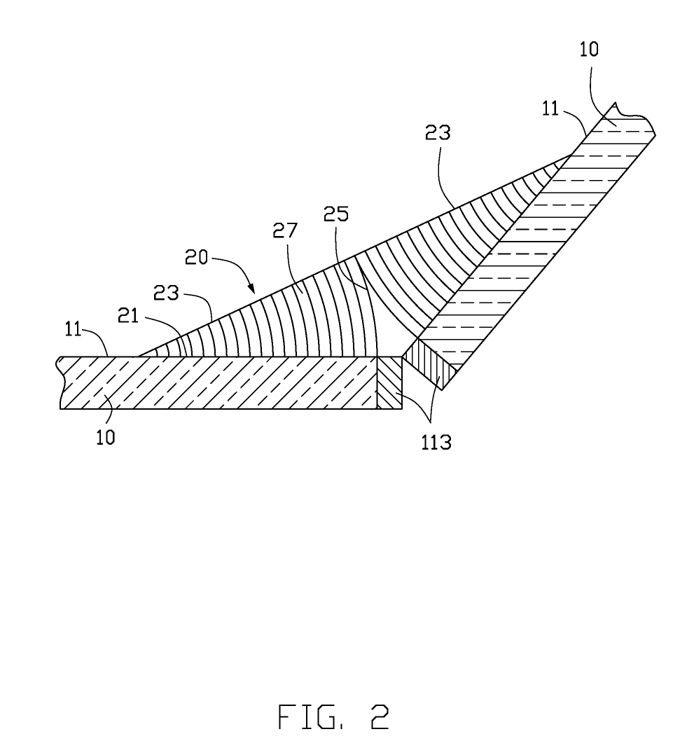

Referring to FIG. 2, two image compensating elements 20 are disposed at a junction of adjacent two display devices 10, and each of the two image compensating elements 20 is located on one display device 10. Each of the image compensating elements 20 is on the front surface 11, within the display area 111, and adjacent to the border area 113 of the display device 10. The image compensating element 20 does not directly contact the border area 113 of the front surface 11. In the present embodiment, a portion of the display area 111 that is not covered by the image compensating element 20 is defined as a main display area, and other portion of the display area 111 that is covered by the image compensating element 20 is defined as an infill display area. The infill display area is outside of the main display area.

Referring to FIG. 2, the image compensating element 20 has a sector shape in cross section. The image compensating element 20 includes a light-incident surface 21, a light-emitting surface 23, and a connecting surface 25 connecting the light-incident surface 21 and the light-emitting surface 23. The light-incident surface 21 covers the display area 111 of the front surface 11 of the display device 10 and does not cover the border area 113. The light-emitting surface 23 intersects with the light-incident surface 21 to form an acute angle, and the connecting surface 25 is a curved surface. The image compensating element 20 includes a plurality of light guiding channels 27. Light guiding paths of the light guiding channels 27 are independent from each other and extend along a direction from the light-incident surface 21 toward the light-emitting surface 23. Each light guiding channel 27 is curved. The light guiding channels 27 are connected to form the image compensating element 20.

Referring to FIG. 2, the two light-emitting surfaces 23 of the two image compensating elements 20 at the junction of two adjacent display devices 10 are coupled together. In the present embodiment, the two light-emitting surfaces 23 of the two image compensating elements 20 at the junction of every adjacent two display devices 10 are coupled into a plane such that the display assembly 100 can display an image without interruptions of the border areas 113 of each of the display devices 10.

Light from the main display area of the display device 10 is direct to the user, and the user can view the screen image of the main display area. Light from the pixels of the infill display area of the display device 10 enters into the light guiding channels 27 from the light-incident surface 21 of the compensating element 20 and is emitted from the light-emitting surface 23 of the image compensating element 20. Since the two light-emitting surfaces 23 of every adjacent two image compensating elements 20 are coupled together, when the user views the display screen of the display assembly 100, the border areas 113 at the junction of adjacent display devices 10 are effectively not visible, so an uninterrupted display can be viewed. The image compensating element 20 extends images corresponding to the infill display areas at the junction of two adjacent display devices 10 above the border areas 113, and the border areas 113 are shielded from view, thus a seamless display can be achieved. Since the image compensating elements 20 are used, the display devices 10 can be visually seamlessly coupled in a two-dimensional direction, and the display effect is good.

Each light guiding channel 27 is a light guiding fiber, and each light guiding fiber extends from the light-incident surface 21 toward the light-emitting surface 23. In the present embodiment, the light guiding fiber may be a plastic optical fiber, a quartz optical fiber, a glass optical fiber, or the like.

In the present embodiment, as shown in FIG. 2, the light-incident surface 21 and the light-emitting surface 23 have a same size of area. The cross-sectional area of each of light guiding fibers remains unchanged along the direction from the light-incident surface 21 to the light-emitting surface 23. In the present embodiment, the light guiding fibers are positioned into a mold and extruded to be a desired shape.

### Second Embodiment

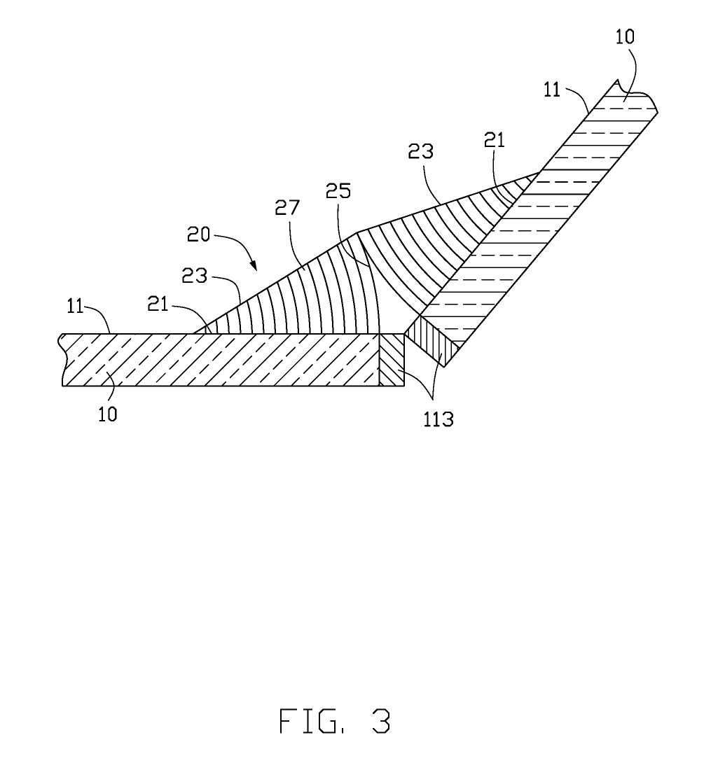

Referring to FIG. 3, in the present embodiment, the junction of adjacent display devices 10 is also provided with two image compensating elements 20 each having a sector shape in cross section. The two light-emitting surfaces 23 of the image compensating element 20 are coupled together, but are not coupled in a single plane. As shown in FIG. 3, the two light-emitting surfaces 23 intersect to form an angled arrangement of less than 180 degrees.

In the present embodiment, as shown in FIG. 3, a size of area of the light-incident surface 21 is not equal to a size of area of the light-emitting surface 23 in the image compensating element 20, and the size of area of the light-incident surface 21 is slightly smaller than that of the light-emitting surface 23. The cross-sectional area of each light guiding fiber can be gradually increased along a direction from the light-incident surface 21 to the light-emitting surface 23. The present embodiment can transform the light guiding fiber into a number of desired shapes by placing the light guiding fiber in a molding die. In the present embodiment, the light guiding fibers are positioned into a mold and extruded to be a desired shape.

In other embodiments, the size of area of the light-incident surface 21 can also be larger than that of the light-emitting surface 23 and the cross-sectional area of each light guiding fiber can also gradually decrease along the direction from the light-incident surface 21 to the light-emitting surface 23.

### Third Embodiment

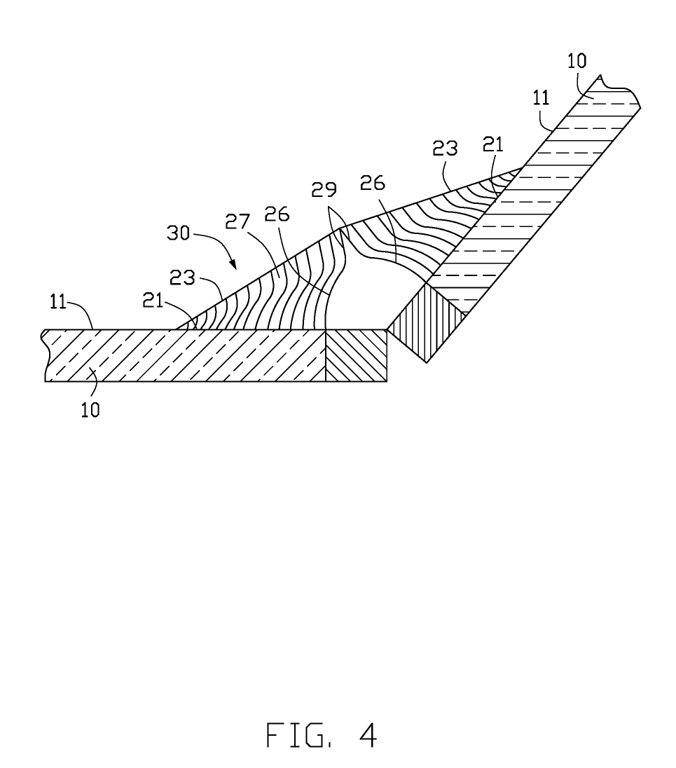

Referring to FIG. 4, in the present embodiment, two image compensation elements 30 are also disposed at the junction of adjacent display devices 10. The image compensation component 30 is different from the image compensation components 20 of the first and second embodiments.

As shown in FIG. 4, in the present embodiment, the image compensating element 30 includes a light-incident surface 21, a light-emitting surface 23, and a first connecting surface 26 and a second connecting surface 29 connecting between the light-incident surface 21 and the light-emitting surface 29. The light-incident surface 21 covers the display area 111 of the front surface 11 of the display device 10 and does not cover the border area 113. The light-emitting surface 23 intersects the light-incident surface 21 to form an acute angle. The first connecting surface 26 is connected between the light-incident surface 21 and the second connecting surface 29, and the second connecting surface 29 is connected between the first connecting surface 26 and the light-emitting surface 23.

The first connecting surface 26 is a curved surface, but is not limited to being a curved surface. The shapes of the first connecting surface 26 and the second connecting surface 29 depend on an extent of bending, shaping, or cutting during a manufacturing process of the image compensating element 30. As shown in FIG. 4, the two light-emitting surfaces 23 of two image compensating elements 30 at the junction of adjacent display devices 10 are coupled together, and the two second connecting surfaces 29 of the two image compensating elements 30 are not attached together but intersect with each other. The two second connecting surfaces 29 form an angle, the angle in this embodiment being acute, but is not limited to being an acute angle. The image compensating element 30 includes a plurality of light guiding fibers 27 shown in FIG. 3, and light guiding paths of the light guiding channels 27 are independent from each other and extend along a direction from the light-incident surface 21 toward the light-emitting surface 23.

The image compensating elements 20, 30 may be formed by extruding a light guiding fiber block (not shown) and cutting the light guiding fiber block after extruding. The light guiding fiber block includes light guiding fibers (not shown) extending in a predetermined direction and closely arranged in an array. The image compensating element formed by extrusion molding can be applied to a display device with a wider or relatively wide border area. Therefore, the display assembly is not restricted to include display devices with narrow borders, but can include display devices with broad borders, which can effectively reduce the cost. The included angle of adjacent display devices can also be adjusted as needed.

The image compensating elements 20, 30 are prepared by placing a light guiding fiber block (not shown) into a mold, and extruding the light guiding fiber block in a high temperature environment to shape the light guiding fibers in the light guiding fiber block. Finally, the extruded light guiding fiber block can be cut to obtain an image compensating element having a desired shape.

The display device 10 can be a liquid crystal display device, an organic light emitting diode display device, a micro-light emitting diode display device, and the like.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A display assembly, comprising:
at least two display devices arranged one by one, each of the at least two display devices comprising a front surface adapted for displaying image, two front surfaces of every adjacent two of the display devices intersecting with each other at an angle of less than 180 degrees, each front surface defining a display area and a border area outside the display area; and
two image compensating elements at a junction of every adjacent two of the display devices, each of the two image compensating elements being on the front surface of one of the adjacent two display devices;
each of the image compensating elements comprising a light-incident surface covering the display area, a light-emitting surface coupling to the light-incident surface, and a connecting surface coupling between the light-incident surface and the light-emitting surface;
wherein each of the image compensating elements comprises a plurality of light guiding channels; light guiding paths of the plurality of light guiding channels are independent from each other and curvedly extend along a direction from the light-incident surface toward the light-emitting surface.

2. The display assembly of claim 1, wherein the two light-emitting surfaces of the two image compensating elements at the junction of the adjacent two display devices are coupled together.

3. The display assembly of claim 2, wherein the two light-emitting surfaces of the two image compensating elements at the junction of the adjacent two display devices are coupled into a plane.

4. The display assembly of claim 1, wherein the light-emitting surface and the light-incident surface of each of the image compensating elements is configured that the light-emitting surface intersects with the light-incident surface to form an acute angle.

5. The display assembly of claim 1, wherein the connecting surface is a curved surface.

6. The display assembly of claim 1, wherein at least one of the image compensating elements is configure that an area size of the light-emitting surface is equal to an area size of the light-incident surface.

7. The display assembly of claim 6, wherein each of the plurality of light guiding channels is a light guiding fiber, a cross-sectional area of each light guiding fiber is constant along a direction from the light-incident surface to the light-emitting surface.

8. The display assembly of claim 1, wherein at least one of the image compensating elements is configure that an area size of the light-emitting surface is not equal to an area size of the light-incident surface.

9. The display assembly of claim 8, wherein each of the plurality of light guiding channels is a light guiding fiber, a cross-sectional area of each light guiding fiber gradually increases or decreases along a direction from the light-incident surface to the light-emitting surface.

10. The display assembly of claim 1, wherein the connecting surface comprises a first connecting surface and a second connecting surface; the first connecting surface is connected between the light-incident surface and the second connecting surface; and the second connecting surface is connected between the first connecting surface and the light-emitting surface.

11. The display assembly of claim 10, wherein the first connecting surface is a curved surface.
